(19) United States
(12) Patent Application Publication
(10) Pub. No.: US 2013/0315817 A1
(43) Pub. Date: Nov. 28, 2013

(54) METHOD FOR REMOVING OXIDATIVE STRESS SUBSTANCES, METHOD FOR LOWERING OXIDATION-REDUCTION POTENTIAL, FILTER MEDIUM, AND WATER

(71) Applicants: Shun Yamanoi, Kanagawa (JP); Seiichiro Tabata, Kanagawa (JP); Machiko Minatoya, Tokyo (JP); Hironori Iida, Kanagawa (JP); Shinichiro Yamada, Kanagawa (JP)

(72) Inventors: Shun Yamanoi, Kanagawa (JP); Seiichiro Tabata, Kanagawa (JP); Machiko Minatoya, Tokyo (JP); Hironori Iida, Kanagawa (JP); Shinichiro Yamada, Kanagawa (JP)

(73) Assignee: SONY CORPORATION, TOKYO (JP)

(21) Appl. No.: 13/984,586

(22) PCT Filed: Feb. 3, 2012
(86) PCT No.: PCT/JP2012/000745

§ 371 Date: Aug. 9, 2013

(30) Foreign Application Priority Data
Feb. 10, 2011 (JP) 2011-026860
Dec. 22, 2011 (JP) 2011-281123

(51) Int. Cl. B01J 20/28; C01B 5/00; C02F 1/28

(52) U.S. Cl. CPC B01J 20/28085; C02F 1/281; C01B 5/00; B01J 20/28083; B01J 20/2808
USPC 423/580.1; 210/660; 502/416

(57) ABSTRACT

[Object] To provide a method for removing oxidative stress substances such as oxygen radical species from a liquid (for example, water) reliably when the liquid is used by a user.

[Solving Means] A method for removing oxidative stress substances according to the present disclosure uses a porous carbon material having a value of a specific surface area based on nitrogen BET method of 10 m²/g or more; a volume of fine pores based on BJH method and MP method of 0.1 cm³/g or more, desirably 0.2 cm³/g or more; to remove oxidative stress substances contained in a liquid.

### TECHNICAL FIELD

The present disclosure relates to a method for removing oxidative stress substances, a method for lowering oxidation-reduction potential, a filter medium and water.

### BACKGROUND ART

In recent years, attention is drawn to water showing reduction properties, such as alkaline ion water, electrolytic reduced water and hydrogen water, from the standpoint of the maintenance of good health (see, for example, Japanese Unexamined Patent Application Publication Nos. 2003-301288, 2002-348208 and 2001-314877.) Also, Medical Associations have proved in recent years that oxidative stress substances including oxygen radical species which is active oxygen species in a broad sense such as superoxide radical, hydroxyl radical, hydrogen peroxide, singlet oxygen, lipid peroxide, nitrogen monoxide, nitrogen dioxide and ozone forms a factor of various diseases and aging. It is said that removal of these oxidative stress substances by taking antioxidative food or beverage and making antioxidative cosmetics act on a skin is very effective in preventing various diseases and preventing aging. Examples of antioxidants which have been used from the past to address the active oxygen include organic molecules such as L-ascorbic acid (vitamin C) and α-tocopherol (vitamin E).

### CITATION LIST

Patent Document 1: Japanese Unexamined Patent Application Publication No. 2003-301288
Patent Document 2: Japanese Unexamined Patent Application Publication No. 2002-348208
Patent Document 3: Japanese Unexamined Patent Application Publication No. 2001-314877

### SUMMARY OF INVENTION

### Problem to be Solved by the Invention

Incidentally, while the presence of natural mineral water having reduction properties (for example, “Hita Tenryosui” produced in Oita, and the like) is also attracting attention in recent years, it has been known recently that the properties of the water having reduction properties may be changed into oxidative properties in the course of time during filling in the factory and transportation until it reaches the consumer. Further, also in liquids other than water, there is a strong demand for removal of oxidative stress substances present in the liquid.

Therefore, an object of the present disclosure is to provide a method for removing oxidative stress substances such as oxygen radical species from a liquid (for example, water) reliably when the liquid is used by a user, a method for obtaining an improved liquid (for example, water), a filter medium suitable for use in these methods, and water obtainable by these methods.

### Means for Solving the Problem

A method for removing oxidative stress substances according to a first embodiment of the present disclosure in order to achieve the above object uses a porous carbon material having a value of a specific surface area based on nitrogen BET method of 10 m²/g or more; a volume of fine pores based on BJH method of 0.2 cm³/g or more, desirably 0.4 cm³/g or more; and a volume of fine pores based on MP method of 0.2 cm³/g or more, desirably 0.4 cm³/g or more; to remove oxidative stress substances contained in a liquid.

A method for removing oxidative stress substances according to a second embodiment of the present disclosure in order to achieve the above object uses a porous carbon material having a value of a specific surface area based on nitrogen BET method of 10 m²/g or more; and a total of volumes of fine pores having a diameter of from 1×10⁻⁹ m to 5×10⁻⁷ m, obtained by non-localized density functional theory method, of 0.1 cm³/g or more, desirably 0.2 cm³/g or more; to remove oxidative stress substances contained in a liquid.

A method for removing oxidative stress substances according to a third embodiment of the present disclosure in order to achieve the above object uses a porous carbon material having a value of a specific surface area based on nitrogen BET method of 10 m²/g or more; and having at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more; to remove oxidative stress substances contained in a liquid.

A method for removing oxidative stress substances according to a fourth embodiment of the present disclosure in order to achieve the above object uses a porous carbon material composite including a porous carbon material and a functional material attached to the porous carbon material; and having a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more; to remove oxidative stress substances contained in a liquid.

A method for lowering oxidation-reduction potential according to the first embodiment of the present disclosure in order to achieve the above object uses a porous carbon material having a value of a specific surface area based on nitrogen BET method of 10 m²/g or more; a volume of fine pores based on BJH method of 0.2 cm³/g or more, desirably 0.4 cm³/g or more; and a volume of fine pores based on MP method of 0.2 cm³/g or more, desirably 0.4 cm³/g or more; to lower the oxidation-reduction potential of a liquid.

A method for lowering oxidation-reduction potential according to the second embodiment of the present disclosure in order to achieve the above object uses a porous carbon material having a value of a specific surface area based on nitrogen BET method of 10 m²/g or more; and a total of volumes of fine pores having a diameter of from 1×10⁻⁹ m to 5×10⁻⁷ m, obtained by non-localized density functional theory method, of 0.1 cm³/g or more, desirably 0.2 cm³/g or more; to lower the oxidation-reduction potential of a liquid.

A method for lowering oxidation-reduction potential according to the third embodiment of the present disclosure in order to achieve the above object uses a porous carbon material having a value of a specific surface area based on nitrogen BET method of 10 m²/g or more; and having at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more; to lower the oxidation-reduction potential of a liquid.

A filter medium according to a first or second embodiment of a filter medium of the present disclosure in order to achieve the above object includes a porous carbon material having a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more; and the filter medium is configured to remove oxidative stress substances contained in a liquid by being immersed in the liquid (first embodiment), or to lower the oxidation-reduction potential of the liquid by being immersed in the liquid (second embodiment).

A filter medium according to a third or fourth embodiment of a filter medium of the present disclosure in order to achieve the above object includes a porous carbon material having a value of a specific surface area based on nitrogen BET method of 10 m²/g or more and a total of volumes of fine pores having a diameter of from 1×10⁻⁹ m to 5×10⁻⁷ m, obtained by non-localized density functional theory method, of 0.1 cm³/g or more, desirably 0.2 cm³/g or more; and the filter medium is configured to remove oxidative stress substances contained in a liquid by being immersed in the liquid (third embodiment), or to lower the oxidation-reduction potential of the liquid by being immersed in the liquid (fourth embodiment).

A filter medium according to a fifth or sixth embodiment of the present disclosure in order to achieve the above object includes a porous carbon material having a value of a specific surface area based on nitrogen BET method of 10 m²/g or more and having at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more; and the filter medium is configured to remove oxidative stress substances contained in a liquid by being immersed in the liquid (fifth embodiment), or to lower the oxidation-reduction potential of the liquid by being immersed in the liquid (sixth embodiment).

A filter medium according to a seventh embodiment of the present disclosure in order to achieve the above object includes a porous carbon material composite including a porous carbon material and a functional material attached to the porous carbon material, which porous carbon material composite has a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more; and the filter medium is configured to remove oxidative stress substances contained in a liquid by being immersed in the liquid.

Water according to the first or second embodiment of the present disclosure in order to achieve the above object is the water from which oxidative stress substances are removed (first embodiment), or the water in which oxidation-reduction potential is lowered (second embodiment); by being impregnated into a porous carbon material having a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more.

Water according to the third or fourth embodiment of the present disclosure in order to achieve the above object is the water from which oxidative stress substances are removed (third embodiment), or the water in which oxidation-reduction potential is lowered (fourth embodiment); by being impregnated into a porous carbon material having a value of a specific surface area based on nitrogen BET method of 10 m²/g or more and a total of volumes of fine pores having a diameter of from 1×10⁻⁹ m to 5×10⁻⁷ m, obtained by non-localized density functional theory method, of 0.1 cm³/g or more, desirably 0.2 cm³/g or more.

Water according to the fifth or sixth embodiment of the present disclosure in order to achieve the above object is the water from which oxidative stress substances are removed (fifth embodiment), or the water in which oxidation-reduction potential is lowered (sixth embodiment); by being impregnated into a porous carbon material having a value of a specific surface area based on nitrogen BET method of 10 m²/g or more and having at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more.

Water according to the seventh embodiment of the present disclosure in order to achieve the above object is the water from which oxidative stress substances are removed; by being impregnated into a porous carbon material composite including a porous carbon material and a functional material attached to the porous carbon material, which porous carbon material composite has a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more.

### Effect of the Invention

In the methods according to the first to fourth embodiments of the present disclosure for removing oxidative stress substances, methods according to the first to third embodiments of the present disclosure for lowering oxidation-reduction potential, filter media according to the first to seventh embodiments of filter media of the present disclosure, and water according to the first to seventh embodiments of the present disclosure, since a value of a specific surface area based on nitrogen BET method, a value of a volume of fine pores and a pore distribution of a porous carbon material or a porous carbon material composite are specified, oxidative stress substances contained in a liquid or water can be reliably removed, and the oxidation-reduction potential of the liquid or water can be reliably lowered. Incidentally, in general, the oxidative stress substances easily receive electrons (that is, the standard oxidation-reduction potential is high in a positive direction). Therefore, when the oxidative stress substances are removed, the ease of electron acceptance is decreased (the ease of electron donation is increased). That is, the oxidation-reduction potential becomes greater towards a negative direction.

### BRIEF DESCRIPTION OF DRAWINGS

FIG. 1 is a graph obtained by examining the relationship between added amount of each of a porous carbon material of Example 1 and activated carbon of Comparative Example 1 and pH.

(A) and (B) of FIG. 2 are a graph obtained by examining the relationship between added amount of each of the porous carbon material of Example 1 and activated carbon of Comparative Example 1 and oxidation-reduction potential, and a graph obtained by examining the changes over time in the oxidation-reduction potential in the porous carbon material of Example 1, respectively.

(A) and (B) of FIG. 3 are graphs showing results of measurement of oxidation-reduction potential of water on commercially available natural water before and after filtration using a porous carbon material of each of Example 2 and activated carbon of Comparative Example 2, and results of measurement of negative charge quantity, respectively.

(A) and (B) of FIG. 4 are a graph showing measurement results of pH and oxidation-reduction potential of commercially available natural water when each of the porous carbon material of Example 3 and activated carbon of Comparative Example 3 was added thereto, and a chart showing the results of measurement of GO-index when each of porous carbon material of Example 4 and activated carbon of Comparative Example 4 was added to commercially available natural water, respectively.

FIG. 5 is a graph showing measurement results of pore diameter distribution obtained by non-localized density functional method of Example 5A, Example 5B, Example 5C and Comparative Example 5A.

FIG. 6 is a graph showing results of evaluation of properties of decomposing hydrogen peroxide, evaluated by spectroscopy, of specimens of Example 5A, Example 5B, Example 5C, Comparative Example 5A, Comparative Example 5B and Comparative Example 5C.

(A) to (D) of FIG. 7 are graphs showing the measured O.D. values for specimens of Example 6A, Example 6B, Comparative Example 6A and Comparative Example 6B, respectively.

FIG. 8 is optical microscope images of cells observed in tests on specimens of Example 6A, Example 6B, Comparative Example 6A and Comparative Example 6B.

FIG. 9 is fluorescence microscope images of epidermal cells observed in tests on specimens of Example 7A, Example 7B, Comparative Example 7A and Comparative Example 7B.

(A) and (B) of FIG. 10 are graphs showing results of measurement of the weight of mice of each test group in Example 8, and results of calculating the average food intake per day.

FIG. 11 is a graph showing TBARS amount measured in Example 8.

(A) and (B) of FIG. 12 are a schematic partial sectional view and a schematic sectional view of a bottle in Example 10.

(A) and (B) of FIG. 19 are a schematic partial sectional view and a partially cutaway schematic view of a modified example of a bottle in Example 10.

### MODES FOR CARRYING OUT THE INVENTION

Hereinafter, with reference to drawings, the present disclosure will be described based on Examples. However, the present disclosure is not limited to the Examples. Various kinds of numerical values and materials in the Examples are illustrations. Description will be carried out in the following order.

1. Descriptions overall, of methods according to first to fourth embodiments of the present disclosure for removing oxidative stress substances, methods according to first to third embodiments of the present disclosure for lowering oxidation-reduction potential, filter media according to first to seventh embodiments of the present disclosure, and water according to first to seventh embodiments of the present disclosure

2. Example 1 (methods according to first to third embodiments of the present disclosure for removing oxidative stress substances, methods according to first to third embodiments of the present disclosure for lowering oxidation-reduction potential, filter media according to first to sixth embodiments of the present disclosure, and water according to first to sixth embodiments of the present disclosure)

3. Example 2 (modification of Example 1)
4. Example 3 (modification of Example 1)
5. Example 4 (modification of Example 1)
6. Example 5 (modification of Example 1)
7. Example 6 (modification of Example 1)
8. Example 7 (modification of Example 1)
9. Example 8 (modification of Example 1)
10. Example 9 (method according to fourth embodiment of the present disclosure for removing oxidative stress substances, filter medium according to seventh embodiment of the present disclosure, and water according to seventh embodiment of the present disclosure)
11. Example 10 (modifications of Examples 1 to 9), and others

[Descriptions overall, of methods according to first to fourth embodiments of the present disclosure for removing oxidative stress substances, methods according to first to third embodiments of the present disclosure for lowering oxidation-reduction potential, filter media according to first to seventh embodiments of the present disclosure, and water according to first to seventh embodiments of the present disclosure]

In methods according to first to fourth embodiments of the present disclosure for removing oxidative stress substances, and in filter media according to first, third, fifth or seventh embodiment of the present disclosure, or the water according thereto, examples of the oxidative stress substances include hydroxyl radical, singlet oxygen, superoxide radical, hydrogen peroxide, lipid peroxide, nitrogen monoxide, nitrogen dioxide and ozone. Here, “oxidative stress substances in a liquid or water are removed” means that from a state in which oxidative stress substances (hydroxyl radical, singlet oxygen, superoxide radical, hydrogen peroxide, lipid peroxide, nitrogen monoxide, nitrogen dioxide and ozone, which is active oxygen species) have been present, it turns into a state in which the oxidative stress substances are changed to water molecules or oxygen molecules, by that the oxidative stress substances are reduced with a porous carbon material or a functional material.

In methods according to first to third embodiments of the present disclosure for lowering oxidation-reduction potential, and in filter media according to second, fourth or sixth embodiment of the present disclosure, or the water according thereto, oxidation-reduction potential of a liquid or water is lowered. Here, when the oxidation state where chlorine, trihalomethane and the oxidative stress substances (hydroxyl radical, singlet oxygen, superoxide radical, hydrogen peroxide, lipid peroxide, nitrogen monoxide, nitrogen dioxide and ozone, which is active oxygen species) are contained is changed, by the removal of those substances, to the state where mineral components (which is considered as residual ash produced in the course of firing and activation, which has been contained in the surface and inside of the porous carbon material) are eluted, the oxidation-reduction potential of the liquid or water is decreased. That is, it is considered that since chlorine, trihalomethane and oxidative stress substances high oxidation-reduction potential in positive (that is, having a high degree of acidity), adsorption by the porous carbon material, removal by the oxidation-reduction reaction, and the elution of a salt of a weak acid and a strong base (such as potassium carbonate) contribute to the decrease of the oxidation-reduction potential. The oxidation-reduction potential of the liquid or water can be measured by using an electrometer having three electrodes including an Ag/AgCl electrode as a reference electrode. The oxidation-reduction potential of the liquid or water after its decrease is desirable to be 250 millivolts or less, more desirably 200 millivolts or less, and even more desirably 150 millivolts or less.

In the methods according to the first to fourth embodiments of the present disclosure for removing oxidative stress substances, the methods according to the first to third embodiments of the present disclosure for lowering oxidation-reduction potential, the filter media according to the first to seventh embodiments of the present disclosure and the water according to the first to seventh embodiments of the present disclosure, for example, due to elution of a small amount of a carbonate produced in the course of carbonization and activation, and, with an increase of ash content by increasing a degree of activation, and, with inductions of hydroxide ions based on proton abstraction from water molecules (H₂O→H⁺+OH⁻) by polar functional groups of negative (═O and —COO⁻) present in the surface of the porous carbon material, the liquid or water can be alkaline, or the pH value can be increased. In addition, by allowing a carboxyl group (obtainable by a nitric acid treatment) or a sulfone group (obtainable by concentrated sulfuric acid) to be produced on the surface of the porous carbon material according to the present disclosure, the liquid or water can be acidic, or the pH value can be decreased. Alternatively, a reducing agent such as hydrogen can be added to the liquid or water. Further, by allowing the liquid or water to pass through the microstructure of the porous carbon material, the structure (cluster) of water can be changed.

In the methods according to the first to fourth embodiments of the present disclosure for removing oxidative stress substances, the methods according to the first to third embodiments of the present disclosure for lowering oxidation-reduction potential and the filter media according to the first to seventh embodiments of the present disclosure, examples of the liquid include water, but are not limited thereto, and also include a lotion and a cleansing agent to remove stain components such as sweat, oils and fats and a lipstick. Further, the water according to the first to seventh embodiments of the present disclosure encompasses, in addition to drinkable water, for example, lotions and cleansing agents to remove stain components such as sweat, oils and fats and a lipstick. Using the material such as porous carbon materials of the present disclosure means to allow a liquid to be brought into contact with the material such as porous carbon materials of the present disclosure. By dipping the material such as porous carbon materials of the present disclosure in the liquid, or by allowing the liquid to pass through the material such as porous carbon materials of the present disclosure, or by allowing it to stand in the liquid, a liquid treatment method for removing oxidative stress substances contained in the liquid can be made. In addition, by dipping the material such as porous carbon materials of the present disclosure in the liquid, or by allowing the liquid to pass through the material such as porous carbon materials of the present disclosure, or by allowing it to stand in the liquid, a liquid treatment method for lowering oxidative stress substances contained in the liquid can be made.

The porous carbon material or porous carbon material composite in the methods according to the first to fourth embodiments of the present disclosure for removing oxidative stress substances, the porous carbon material in the methods according to the first to third embodiments of the present disclosure for lowering oxidation-reduction potential, the porous carbon material or porous carbon material composite in the filter media according to the first to seventh embodiments of the present disclosure, and the porous carbon material or porous carbon material composite for obtaining the water according to the first to seventh embodiments of the present disclosure (hereinafter, in some cases, these porous carbon materials and porous carbon material composites are generically referred to as a “material such as porous carbon materials of the present disclosure”) can be used in a form of a sheet, in a state of being filled in a column or a cartridge, in a state of being housed in a water-permeating bag, in a state of being formed into a desired shape with a binder, or in a state of powder, for example. In some cases, a surface of the porous carbon material or porous carbon material composite can be subjected to hydrophilic or hydrophobic treatment, to be used.

An apparatus suitable for incorporating the material such as porous carbon materials of the present disclosure, specifically, a water cleaner (hereinafter, in some cases, referred to as “water cleaner in the present disclosure”) may have a structure (combined use of the material such as porous carbon materials of the present disclosure and a filtration membrane) that further includes a filtration membrane (for example, hollow fiber membrane or flat membrane having 0.4 μm to 0.01 μm holes), a structure (combined use of the material such as porous carbon materials of the present disclosure and a reverse osmosis membrane) that further includes a reverse osmosis membrane (RO), a structure (combined use of the material such as porous carbon materials of the present disclosure and a ceramic filter medium) that further includes a ceramic filter medium (ceramic filter medium having fine pores), or a structure (combined use of the material such as porous carbon materials of the present disclosure and an ion exchange resin) that further includes an ion exchange resin, for example.

As types of the water cleaners of the present disclosure, a continuous water cleaner, a batch water cleaner and a reverse osmosis membrane water cleaner can be mentioned, or a faucet-coupled water cleaner in which a water cleaner body is directly attached to an tip part of a water faucet, a stationary water cleaner (also referred to as top sink water cleaner or table top water cleaner), a water faucet-integrated water cleaner in which a water cleaner is incorporated in a water faucet, a under-sink water cleaner that is installed in a sink of a kitchen (built-in water cleaner), a pot water cleaner in which a water cleaner is incorporated in a container such as a pot and a pitcher (pitcher water cleaner), a central water cleaner that is directly attached to a water pipe after a water meter, a portable water cleaner and a straw water cleaner can be mentioned. The water cleaner in the present disclosure can have a constitution and structure the same as those of a water cleaner of the past. In the water cleaner in the present disclosure, the material such as porous carbon materials of the present disclosure can be used in a cartridge, for example, and to the cartridge, a water inlet and a water outlet may be provided. The “water” to be a target by the water cleaner in the present disclosure is not limited to the “water” defined in “3. Terms and Definitions” of JIS S3201: 2010 “Testing methods for household water cleaners”.

Alternatively, as a member suitable for incorporating the material such as porous carbon materials of the present disclosure, a cap or a cover in a bottle (so-called PET bottle), a laminate container, a plastic container, a glass container, a glass bin, and the like, which are provided with a cap, a cover, a straw member, or a spray member can be mentioned. Here, when the material such as porous carbon materials of the present disclosure is disposed inside a cap or a cover, and a liquid or water (drinkable water, a lotion, or the like) in a bottle, a laminate container, a plastic container, a glass container, a glass bin or the like is passed through the filter medium of the present disclosure disposed inside the cap or cover and is drunk, or used, oxidative stress substances in the liquid or water can be removed, or, the oxidation-reduction potential of the liquid or water can be lowered. Alternatively, a form in which the material such as porous carbon materials of the present disclosure is housed in a bag having water permeability, and the bag is put in a liquid or water (drinkable water, a lotion, or the like) inside various kinds of containers such as a bottle (so-called PET bottle), a laminate container, a plastic container, a glass container, a glass bottle, a pot and a pitcher, can be employed. By employing such forms of use, for example, it can surely prevent occurrences of phenomena in which a liquid or water having reductive properties is changed with time to one having oxidative properties.

In the case where a raw material of the material such as porous carbon materials in the present disclosure is a plant-derived material containing silicon (Si), specifically, the porous carbon material is desirably one having a plant-derived material in which the silicon (Si) content is 5% by mass or more, as the raw material, which porous carbon material has a silicon (Si) content of 5% by mass or less, desirably 3% by mass or less, and more desirably 1% by mass or less, but is not limited thereto.

A porous carbon material which make up the material such as porous carbon materials in the present disclosure (hereinafter, in some cases, referred to as a “porous carbon material of the present disclosure”) can be obtained, for example, in such a manner that after a plant-derived material is carbonized at 400° C. to 1400° C., the carbonized material is treated with an acid or an alkali. In such a method for manufacturing the porous carbon material of the present disclosure (hereinafter, in some cases, simply referred to as a “method for manufacturing the porous carbon material”), a material that is obtained by carbonizing the plant-derived material at 400° C. to 1400° C. and before an acid or alkali treatment is applied is referred to a “porous carbon material precursor” or a “carbonaceous substance”.

In the method for manufacturing the porous carbon material, after an acid or alkali treatment, a step of conducting an activation treatment may be included, and, after the activation treatment, an acid or alkali treatment may be conducted. Further, in the method for manufacturing the porous carbon material including such a desirable form, although depending on the plant-derived material being used, before carbonizing the plant-derived material, at a temperature (for example, 400° C. to 700° C.) lower than a temperature for carbonizing, the plant-derived material may be preheated (pre-carbonizing treatment) in a state where oxygen is shut off. Thereby, since a tar component that would be generated in the course of carbonization can be extracted, the tar component that would be generated in the course of carbonization can be reduced or removed. A state where oxygen is shut off can be achieved by using, for example, an inert gas atmosphere such as nitrogen gas and argon gas, or a vacuum atmosphere, or a kind of smothering state of the plant-derived material. Further, in the method for manufacturing the porous carbon material, although depending on the plant-derived material, in order to reduce mineral components or moisture contained in the plant-derived material, or, in order to prevent an unusual odor from occurring in the course of carbonization, the plant-derived material may be dipped in an alcohol (for example, methyl alcohol, ethyl alcohol, or isopropyl alcohol). In the method for manufacturing the porous carbon material, after that, a pre-carbonizing treatment may be conducted. Examples of materials that are desirable to be heated in an inert gas atmosphere include plants that abundantly generate pyroligneous acid (tar and light oil). Further, examples of materials that are desirable to be treated with alcohol include seaweeds that abundantly contain iodine or various kinds of minerals.

According to the method for manufacturing the porous carbon material, the plant-derived material is carbonized at 400° C. to 1400° C. Here, the carbonization generally means to heat an organic substance (a plant-derived material in the porous carbon material of the present disclosure) to convert to a carbonaceous substance (for example, see JIS M0104-1984). As an atmosphere for carbonization, an atmosphere where oxygen is shut off can be mentioned, and, specifically, a vacuum atmosphere, an inert gas atmosphere such as nitrogen gas and argon gas, and an atmosphere where a material of plant origin is put into a kind of smothering state can be mentioned. An example of a rate of temperature increase until reaching the carbonization temperature, under such an atmosphere, may be 1° C./min or more, desirably 3° C./min or more, and more desirably 5° C./min or more, but is not limited thereto. Further, an example of the upper limit of a carbonization time may be 10 hours, desirably 7 hours, and more desirably 5 hours, without particularly limiting thereto. The lower limit of a carbonization time can be set to a time where the plant-derived material is surely carbonized. Further, the plant-derived material may be pulverized to a desired particle size, and may be classified, as desired. The plant-derived material may be pre-washed. Alternatively, the obtained porous carbon material precursor or porous carbon material may be pulverized to a desired particle size, and may be classified, as desired. Or, the porous carbon material after the activation treatment may be pulverized to a desired particle size, and may be classified, as desired. Further, the finally obtained porous carbon material may be subjected to sterilization treatment. Without particularly limiting a type, a formation, and a structure of a furnace used for carbonization, either a continuous furnace or a batch furnace can be used.

In the manufacture of the porous carbon material composite, after obtaining a porous carbon material by treatment with acid or alkali, a functional material may be attached to the porous carbon material. After the treatment with acid or alkali and before the attachment of the functional material to the porous carbon material, a process of performing activation treatment may be included. Examples of the functional material are platinum (Pt) or a combination of platinum (Pt) and palladium (Pd). The functional material can be attached to the porous carbon material as fine particles or a thin film, for example. Specifically, a state in which the fine particles of the functional material are attached to the surface (including within pores) of the porous carbon material, the functional material in a thin film state is attached to the surface of the porous carbon material, and a state attached in sea-island form (if the surface of the porous carbon is the “sea”, the functional material corresponds to the “island”) can be mentioned. The term “attach” refers to a phenomenon in which different materials are adhered. Examples of methods for allowing the functional material to be attached to the porous carbon material include a method in which the porous carbon material is immersed into the solution containing the functional material to precipitate the functional material onto the surface of the porous carbon material; a method in which the functional material is precipitated onto the surface of the porous carbon material by electroless plating (chemical plating) or a chemical reduction reaction; a method in which the porous carbon material is immersed into a solution containing the precursor of the functional material, and by a heat treatment the functional material is precipitated onto the surface of the porous carbon material; a method in which the porous carbon material is immersed into a solution containing the precursor of the functional material, and by an ultrasonic irradiation treatment the functional material is precipitated onto the surface of the porous carbon material; and a method in which the porous carbon material is immersed into a solution containing the precursor of the functional material, and by making a sol-gel reaction the functional material is precipitated onto the surface of the porous carbon material.

In the method for manufacturing the porous carbon material, as was described above, when an activation treatment is conducted, the number of micro pores (described below) having a pore diameter smaller than 2 nm can be increased. As a method of the activation treatment, a gas activation method and a chemical activation method can be mentioned. Here, the gas activation method is a method by using oxygen, water vapor, carbon dioxide, air or the like as an activator, and by heating a porous carbon material under such an atmosphere, at 700° C. to 1400° C., desirably at 700° C. to 1000° C., and more desirably at 800° C. to 1000° C., for several tens of minutes to several hours, so that a fine structure is developed due to volatile components or carbon molecules in the porous carbon material. More specifically, a heating temperature may be appropriately selected based on a type of the plant-derived material, a type and a concentration of gas, and the like. A chemical activation method is a method in which in place of oxygen or water vapor used in the gas activation method, zinc chloride, iron chloride, calcium phosphate, calcium hydroxide, magnesium carbonate, potassium carbonate, sulfuric acid or the like is used to activate, the resultant is washed with hydrochloric acid, pH of which is adjusted with an alkaline aqueous solution, and the resultant is dried.

On a surface of the material such as porous carbon materials of the present disclosure, a chemical treatment or a molecular modification may be applied. As a chemical treatment, for example, a treatment in which carboxyl groups are generated on the surface by a nitric acid treatment can be mentioned. Further, by conducting a treatment the same as the activation treatment with water vapor, oxygen, alkali, or the like on the surface of the porous carbon material, various kinds of functional groups such as a hydroxyl group, a carboxyl group, a ketone group and an ester group can be generated. Further, by reacting with a chemical species or a protein having a hydroxyl group, a carboxyl group, an amino group, or the like, which is capable of reacting with a porous carbon material, a molecular modification can be conducted.

According to a method for manufacturing the porous carbon material, by treating with an acid or an alkali, a silicon component in the plant-derived material after carbonization is allowed to be removed. Here, as a silicon component, silicon oxides such as silicon dioxide, silicon oxide, and silicon oxide salts can be mentioned. Thus, when the silicon component in the plant-derived material after carbonization is removed, a porous carbon material having a large specific surface area can be obtained. In some instances, a dry etching method may be used to remove the silicon component in the plant-derived material after carbonization. That is, in the desired form of the porous carbon material according to the present disclosure, the plant-derived material containing silicon (Si) is used as the raw material, and in converting the plant-derived material into the porous carbon material precursor or the carbonaceous substance, by carbonizing the plant-derived material at high temperature (for example, at 400° C. to 1400° C.), the silicon contained in the plant-derived material becomes the silicon components such as silicon dioxide (SiO₂), silicon oxide and a salt of silicon oxide (silicon oxides), and not silicon carbide (SiC). However, the silicon components (silicon oxides) contained in the plant-derived material before the carbonization are not substantially changed, even when the carbonization is performed at high temperature (for example, at 400° C. to 1400° C.). Therefore, when the acid or alkali (or base) treatment is then performed, the silicon components (silicon oxides) such as silicon dioxide, silicon oxide and a salt of silicon oxide are removed. As a result, there can be provided a high specific surface area value measured by the nitrogen BET method. Furthermore, the desired form of the porous carbon material according to the present disclosure is an environmentally friendly material derived from natural resources, and the microstructure thereof can be obtained by treating the silicon components (silicon oxides) originally contained in the raw materials of the plant-derived material with acid or alkali, and removing such components. Consequently, the arrangement of the pores maintains the biological order of the plants.

As described above, the porous carbon material may have a plant-derived material as a raw material. Here, as a plant-derived material, husks and straws of rice, barley, wheat, rye, Japanese millet, foxtail millet, and the like; coffee beans, tea leaves (for example, leaves of green tea and black tea), sugar canes (more specifically, bagasse), corns (more specifically, cores of corns), fruit skin (for example, skin of citrus fruits such as orange skin, grapefruit skin mandarin orange skin, and skin of banana), or reeds and Wakame stems can be mentioned without limiting thereto. Other than the above, for example, vascular plants that live on land, ferns, bryophytes, algae, and seaweeds can be mentioned. These materials may be used singularly or in a combination of several kinds thereof as a raw material. Further, both a shape and a form of the plant-derived material are not particularly limited, for example, husks or straws may be used as it is, or dried products can be used. Further, materials after various kinds of processing such as fermentation process, roasting process and extraction process, in food and beverage processing of beer, liquor or the like, can also be used. In particular, from the viewpoint of recycling industrial wastes, it is desirable that straws and husks after processing of threshing or the like are used. These straws and husks after processing can be abundantly and readily available, for example, from agriculture cooperatives, alcohol manufacturers, and food-processing companies.

In the material such as porous carbon materials of the present disclosure, non-metal elements such as magnesium (Mg), potassium (K), calcium (Ca), phosphorus (P) and sulfur (S), and metal elements such as transition elements may be contained. A content of magnesium (Mg) of 0.01% by mass or more and 3% by mass or less, a content of potassium (K) of 0.01% by mass or more and 3% by mass or less, a content of calcium (Ca) of 0.05% by mass or more and 3% by mass or less, a content of phosphorus (P) of 0.01% by mass or more and 3% by mass or less, and a content of sulfur (S) of 0.01% by mass or more and 3% by mass or less can be mentioned. Contents of these elements are desirable to be small from the viewpoint of an increase in a value of a specific surface area. A porous carbon material may contain other elements than the above elements, and it goes without saying that also ranges of contents of the various kinds of elements may be altered.

In the present disclosure, an analysis of various elements can be performed by energy dispersive X-ray spectrometry with, for example, an energy dispersive X-ray spectrometer (for example, JED-2200F manufactured by JEOL). Here, measurement conditions may be set to, for example, a scanning voltage of 15 kV and an irradiation current of 10 μA.

The material such as porous carbon materials of the present disclosure has many fine pores. In fine pores, “meso fine pores” having a pore diameter from 2 nm to 50 nm, and “micro fine pores” having a pore diameter smaller than 2 nm, and “macro fine pores” having a pore diameter exceeding 50 nm are included. Specifically, for example, the fine pores include many fine pores having a pore diameter of 20 nm or less, and especially, many fine pores having a pore diameter of 10 nm or less, as meso fine pores. Besides, the fine pores include many fine pores having a pore diameter of about 1.9 nm, those having a pore diameter of about 1.5 nm, and those having a pore diameter of about 0.8 nm to 1.0 nm, as micro fine pores. In the material such as porous carbon materials of the present disclosure, a volume of fine pores by BJH method is desirable to be 0.4 cm³/g or more, and more desirably, 0.5 cm³/g or more.

In the material such as porous carbon materials of the present disclosure, a value of a specific surface area by nitrogen BET method (hereinafter, in some cases, simply referred to as “value of specific surface area”) is desirable to be 50 m²/g or more, more desirably 100 m²/g or more, and even more desirably 400 m²/g or more, for obtaining even better functionality.

The nitrogen BET method is a method in which nitrogen as adsorbate molecules is adsorbed onto and desorbed from the adsorbent (here, the porous carbon material) to measure an adsorption isotherm, and the measurement data is analyzed based on a BET formula represented by the formula (1). Based on this method, a specific surface area, a fine pore volume and the like can be calculated. Specifically, in the case of calculating the specific surface area by nitrogen BET method, first, nitrogen as adsorbate molecules is adsorbed onto and desorbed from the porous carbon material to obtain the adsorption isotherm. Then, from the adsorption isotherm thus obtained, [p/{Vₐ(p₀−p)}] is calculated based on the formula (1) or on the formula (1′) obtained by modification of the formula (1), and the calculation result is plotted against the equilibrium relative pressure (p/p₀). Next, regarding the plot as a straight line, the inclination s (=[(C−1)/(C·Vₘ)]) and the intercept i (=[1/(C·Vₘ)]) of the straight line are calculated based on the least squares method. Then, from the inclination s and the intercept i thus obtained, Vₘ and C are calculated based on the formula (2-1) and the formula (2-2). Further, the specific surface area a_{sBET} is calculated from Vₘ based on the formula (3) (see the manual for BELSORP-mini and BELSORP analysis software, made by BEL Japan, Inc., pp. 62 to 66). Incidentally, the nitrogen BET method is a measuring method according to the “Measuring method for specific surface area of fine ceramic powders by gas adsorption BET method” defined by JIS R 1626-1996.

Vₐ=(VₘC·p)/[(p₀−p){1+(C−1)(p/p₀)}] (1)

[p/{Vₐ(p₀−p)}]=[(C−1)/(C·Vₘ)](p/p₀)+[1/(C·Vₘ)] (1′)

Vₘ=1/(s+i) (2-1)

C=(s/i)+1 (2-2)

a_{sBET}=(VₘL·σ)/22414 (3)

where

Vₐ: adsorption amount;
Vₘ: adsorption amount of monomolecular layer;
p: pressure of nitrogen at equilibrium;
p₀: saturated vapor pressure of nitrogen;
L: Avogadro's number; and
σ: adsorption cross section of nitrogen.

In the case of calculating the fine pore volume Vₚ by the nitrogen BET method, for example, linear interpolation is applied to the adsorption data of the adsorption isotherm obtained, and the adsorption amount V at a relative pressure set by a fine pore volume calculation relative pressure is obtained. From this adsorption volume V, the fine pore volume Vₚ can be calculated based on the formula (4) (see the Manual for BELSORP-mini and BELSORP analysis software, made by BEL Japan, Inc., pp. 62 to 65). Incidentally, the fine pore volume based on the nitrogen BET method may hereinafter be referred to simply as “fine pore volume”).

Vₚ=(V/22414)×(M_{g}/ρ_{g}) (4)

where

V: adsorption amount at relative pressure;
M_{g}: molecular weight of nitrogen; and
ρ_{g}: density of nitrogen.

The pore diameter of meso fine pores can, for example, be calculated as a pore size distribution from the fine pore volume variation rate relative to the pore diameter, based on the BJH method. The BJH method is a method that is widely used as a pore size distribution analyzing method. In the case of analyzing the pore size distribution based on the BJH method, first, nitrogen as adsorbate molecules is adsorbed onto and desorbed from a porous carbon material to obtain a desorption isotherm. Next, based on the desorption isotherm thus obtained, a thickness of an adsorbed layer at the time of stepwise adsorption/desorption of adsorbate molecules from the condition where the fine pores are filled with the adsorbate molecules (for example, nitrogen) and an inside diameter (twice the core radius) of the pores generated in that instance are obtained, then the fine pore radius rₚ is calculated based on the formula (5), and the fine pore volume is calculated based on the formula (6). Then, based on the fine pore radius and the fine pore volume, the fine pore volume variation rate (dVₚ/drₚ) relative to the pore diameter (2rₚ) is plotted, whereby the pore size distribution curve is obtained (see the Manual for BELSORP-mini and BELSORP analysis software, made by BEL Japan, Inc., pp. 85 to 88).

rₚ=t+rₖ (5)

Vₚₙ=RₙdVₙ−Rₙ·dtₙ·c·ΣAₚⱼ (6)

where

Rₙ=rₚₙ²/(rₖₙ−1+dtₙ)² (7)

where
rₚ: fine pore radius;
rₖ: core radius (inside diameter/2) in the case where an adsorbed layer with a thickness t is adsorbed on the inner wall of fine pores with a fine pore radius rₚ at that pressure;
Vₚₙ: fine pore volume when n-th adsorption/desorption of nitrogen is generated;
dVₙ: variation in that instance;
dtₙ: variation of thickness tₙ of the adsorbed layer when the n-th adsorption/desorption of nitrogen is generated;
rₖₙ: core radius in that instance;
c: constant; and
rₚₙ: pore diameter when the n-th adsorption/desorption of nitrogen is generated. Besides, ΣAₚⱼ is the integrated value of the area of wall surfaces of fine pores from j=1 to j=n−1.

The pore diameter of micro fine pores can be calculated as a pore size distribution from the fine pore volume variation rate relative to the pore diameter, based on, for example, the MP method. In the case of analyzing the pore size distribution by the MP method, first, nitrogen is adsorbed onto the porous carbon material to obtain an adsorption isotherm. Next, the adsorption isotherm is converted into fine pore volume relative to a thickness t of the adsorbed layer (plotted against t). Then, based on the curvature of the plot (variation of fine pore volume relative to variation in thickness t of adsorbed layer), a pore size distribution curve can be obtained (see the Manual for BELSORP-mini and BELSORP analysis software, made by BEL Japan, Inc., pp. 72 to 73 and p. 82).

In the non-localized density functional theory method (NLDFT method) specified in JIS Z8831-2: 2010 “A fine pore distribution and fine pore characteristics of powder (solid)—the second part: A method of measuring a meso fine pore and a macro fine pore based on gas adsorption” and JIS Z8831-3: 2010 “A pore diameter distribution and fine pore characteristics of powder (solid)—the third part: A method of measuring a micro fine pore based on gas adsorption”, a software that comes with an automatic specific surface area/fine pore distribution measuring apparatus “BELSORP-MAX” manufactured by BEL JAPAN, INC. is used as analysis software. A model is formed so as to have a cylindrical shape and carbon black (CB) is assumed as the prerequisite, and a distribution function of a fine pore distribution parameter is set as “no-assumption”. The smoothing is carried out ten times for the resulting distribution data.

The porous carbon material precursor is treated with an acid or an alkali. In this case, as a specific treatment method, for example, a method of dipping the porous carbon material precursor in an aqueous solution of an acid or an alkali, or a method of causing the porous carbon material precursor and an acid or an alkali to react with each other in a gas phase can be mentioned. More specifically, when the porous carbon material precursor is treated with an acid, a fluorine compound that shows an acidic property, such as hydrogen fluoride, a hydrofluoric acid, ammonium fluoride, calcium fluoride and sodium fluoride can be mentioned. When the fluorine compound is used, an amount of fluorine elements may be four times larger than the amount of silicon elements in a silicon component contained in the porous carbon material precursor, and a concentration of a fluorine compound aqueous solution is desirably 10% by mass or more. When the silicon components (such as the silicon dioxide) contained in the porous carbon material precursor are removed away by using a hydrofluoric acid, the silicon dioxide reacts with the hydrofluoric acid as shown either in Chemical Formula (A) or in Chemical Formula (B) and is removed away either as a hexafluorosilicic acid (H₂SiF₆) or as silicon tetrafluoride (SiF₄). Thus, a porous carbon material can be obtained. Then, after that, the rinsing and the drying may be conducted.

SiO₂+6HF→H₂SiF₆+2H₂O (A)

SiO₂+4HF→SiF₄+2H₂O (B)

On the other hand, when the porous carbon material precursor is treated with an alkali (base), sodium hydroxide, for example, can be used as the alkali. When an aqueous solution of the alkali is used, pH of an aqueous solution may be 11 or more. When the silicon components (for example, silicon dioxide) contained in the porous carbon material precursor are removed away with an aqueous solution of sodium hydroxide, silicon dioxide reacts with the sodium hydroxide as shown in chemical formula (C) by heating the aqueous solution of sodium hydroxide and is removed away as sodium silicate (Na₂SiO₃), thereby a porous carbon material can be obtained. Also, when the porous carbon material precursor is treated by reacting with sodium hydroxide in a gas phase, silicon dioxide reacts with the sodium hydroxide as shown in chemical formula (C) by heating a solid substance of sodium hydroxide and is removed away as sodium silicate (Na₂SiO₃), thereby a porous carbon material can be obtained. Then, after that, the rinsing and the drying may be conducted.

SiO₂+2NaOH→Na₂SiO₃+H₂O (C)

Or, as the porous carbon material of the present disclosure, for example, also a porous carbon material disclosed in Japanese Unexamined Patent Application Publication No. 2010-106007 which includes vacancies having three-dimensional regularity (porous carbon material having a so-called inverted-opal structure), specifically, a porous carbon material which includes spherical vacancies that have an average diameter of 1×10⁻⁹ to 1×10⁻⁵ m being three-dimensionally disposed, and which has the specific surface area of 3×10² m²/g or more. Desirably, a porous carbon material which includes vacancies disposed in an arrangement corresponding macroscopically to a crystal structure, or vacancies disposed on a surface thereof in an arrangement macroscopically corresponding to a (111) plane orientation in a face-centered cubic structure can be used.

### Example 1

Example 1 relates to methods according to the first to third embodiments of the present disclosure for removing oxidative stress substances, methods according to the first to third embodiments of the present disclosure for lowering oxidation-reduction potential, filter media according to the first to sixth embodiments of the present disclosure, and water, or more specifically, drinkable water or lotions, according to the first to sixth embodiments of the present disclosure.

A porous carbon material to be used in a method for removing oxidative stress substances or a method for lowering oxidation-reduction potential of Example 1, a porous carbon material which makes up a filter medium of Example 1 and a porous carbon material to be used in order to obtain some water (drinkable water or a lotion) of Example 1, according to an expression of a method for removing oxidative stress substances or a method for lowering oxidation-reduction potential according to the first embodiment of the present disclosure, a filter medium according to the first or second embodiment of a filter medium of the present disclosure and water according to the first or second embodiment of the present disclosure, have a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more. Further, according to an expression of a method for removing oxidative stress substances or a method for lowering oxidation-reduction potential according to the second embodiment of the present disclosure, a filter medium according to the third or fourth embodiment of a filter medium of the present disclosure and water according to the third or fourth embodiment of the present disclosure, the porous carbon material has a value of a specific surface area based on nitrogen BET method of 10 m²/g or more and a total of volumes of fine pores having a diameter of from 1×10⁻⁹ m to 5×10⁻⁷ m, obtained by non-localized density functional theory method (NLDFT method) (referred to as “volume A” for convenience), of 0.1 cm³/g or more, desirably 0.2 cm³/g or more. Still further, according to an expression of a method for removing oxidative stress substances or a method for lowering oxidation-reduction potential according to the third embodiment of the present disclosure, a filter medium according to the fifth or sixth embodiment of the present disclosure and water according to the fifth or sixth embodiment of the present disclosure, the porous carbon material has a value of a specific surface area based on nitrogen BET method of 10 m²/g or more and has at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more. By allowing such a porous carbon material to be immersed in a liquid (water), oxidative stress substances in the liquid (water) are removed, or, the oxidation-reduction potential of the liquid (water) is lowered. Further, the filter medium removes oxidative stress substances contained in a liquid (water) by being immersed in the liquid (water), or lowers the oxidation-reduction potential of the liquid (water) by being immersed in the liquid (water). Still further, the water is the water (drinkable water or a lotion) from which oxidative stress substances are removed, or the water (drinkable water or a lotion) in which oxidation-reduction potential is lowered, by being impregnated into the porous carbon material.

In Example 1, as a plant-derived material that is a raw material of the porous carbon material, rice (paddy) husk was used. The porous carbon material in Example 1 is obtained by carbonizing husk as a raw material into a carbonaceous substance (porous carbon material precursor), followed by treating with an acid. Hereinafter, a method for manufacturing the porous carbon material in Example 1 will be described.

In manufacture of a porous carbon material in Example 1, a plant-derived material was carbonized at 400° C. to 1400° C. and, after that, by treating with an acid or an alkali, a porous carbon material was obtained. That is, firstly, husks of rice were heated (pre-carbonizing treatment) in an inert gas atmosphere. Specifically, husks of rice were carbonized by heating at 500° C. for 5 hours in a nitrogen gas flow to obtain a carbide. When such a treatment is applied, a tar component to be generated in the following carbonizing treatment can be reduced or removed. Thereafter, 10 g of the carbide was charged in an alumina crucible and heated up to 800° C. at a rate of temperature increase of 5° C./min in a nitrogen gas flow (10 L/min). Then, after carbonizing at 800° C. for 1 hour to convert to a carbonaceous substance (porous carbon material precursor), the carbonaceous substance was cooled to room temperature. During carbonizing and cooling, a nitrogen gas was continued to flow. Next, the porous carbon material precursor was treated with an acid by dipping in an aqueous solution of 46% by volume of hydrofluoric acid overnight, and, after that, the resultant was washed using water and ethyl alcohol until pH7 was obtained. Then, after drying at 120° C., by activating by heating at 900° C. for 3 hours in a water vapor (5 L/min), a porous carbon material of Example 1 was obtained.

As Comparative Example 1, an activated carbon made of coconut shells manufactured by Wako Pure Chemical Industries Ltd. was used. As Comparative Example 2, which will be described later, an activated carbon made of coconut shells manufactured by Kuraray Chemical Co., Ltd. was used.

BELSORP-mini (manufactured by BEL JAPAN INC.) was used as a measurement instrument for obtaining the specific surface area and the fine pore volume, and a test for adsorbing and desorbing nitrogen was carried out. With regard to the measurement condition, a measurement equilibrium relative pressure (p/p₀) was set in the range of 0.01 to 0.99. Also, the specific surface area and the fine pore volume were calculated based on the BELSORP analysis software. The fine pores of the porous carbon material were measured by mercury porosimetry. Specifically, by using a mercury porosimeter (trade name: PASCAL440, manufactured by Thermo Electron Corporation), mercury porosimetry was conducted. A fine pore measurement region was set to 10 μm to 2 nm. In addition, the test for adsorbing and desorbing nitrogen was carried out by using the measurement instrument described above, thereby calculating the pore diameter distribution of the meso fine pores and the micro fine pores based on both the BJH method and the MP method using the BELSORP analysis software. In addition, the automatic specific surface area/pore distribution measuring apparatus “BELSORP-MAX” manufactured by BEL JAPAN, INC. was used for the analysis based on the non-localized density functional theory method. It is noted that for the measurement, drying was carried out at 200° C. for 3 hours as a pretreatment for a specimen.

When a specific surface area and a volume of fine pores of each of the porous carbon materials of Examples 1 and 2, a porous carbon material composite of Example 9 which will be described later, and the activated carbon of Comparative Example 2 were measured, results shown in Table 1 were obtained. In Table 1, and in Table 5 which will be described later, a “specific surface area” indicates a value of a specific surface area by the nitrogen BET method, and a unit thereof is m²/g. Further, a “MP method”, “BJH method” and “mercury porosimetry” indicate measurement results of volumes of fine pores (micro fine pores) by the MP method, measurement results of volumes of fine pores (meso fine pore to macro fine pore) by the BJH method and measurement results of volumes of fine pores by mercury porosimetry, respectively, and a unit thereof is cm³/g. Further, results of the measurement based on the NLDFT method are shown in Table 2. In addition, a value of sum total of volumes of all fine pores is equivalent to the value of volume A which is described above.

TABLE 1

| | Specific | | | |
|---|---|---|---|---|
| | surface | MP | BJH | Mercury |
| | area | method | method | porosimetry |
| Example 1 | 1700 | 0.65 | 1.08 | 4.12 |
| Example 2 | 1210 | 0.56 | 0.78 | 2.8 |
| Example 9 | 1286 | 0.50 | 0.65 | |
| Comparative | 1231 | 0.56 | 0.14 | 1.7 |
| Example 1 | | | | |
| Comparative | 975 | 0.38 | 0.08 | 1.20 |
| Example 2 | | | | |

TABLE 2

| | | Sum total of volumes |
|---|---|---|
| | Volume ratio | of all fine pores |
| Example 1 | 0.479 | 1.33 cm³/g |
| Example 2 | 0.402 | 1.53 cm³/g |
| Example 9 | 0.432 | 1.38 cm³/g |
| Comparative | 0.100 | 0.76 cm³/g |
| Example 1 | | |
| Comparative | 0.021 | 0.69 cm³/g |
| Example 2 | | |

Amounts of removal of hydroxyl radicals (OH•) in water by the porous carbon material of Example 1, the porous carbon material composite of Example 9 which will be described later, and the activated carbon of Comparative Example 1 were measured by an electron spin resonance apparatus (ESR). Specifically, 15 milligrams of a specimen was added to 50 milliliters of an aqueous solution capable of generating hydroxyl radicals, followed by stirring for 1 hour, and the resulting solution was subjected to measurement by the ESR. As a result, the relative amount of removal of the hydroxyl radicals, when Comparative Example 1 was regarded as “1”, was 4.0 in Example 1. The amount was 9.8 in Example 9 which will be described later.

In addition, measurement results of pH and oxidation-reduction potential of water when using the porous carbon material of Example 1, and activated carbon of Comparative Example 1, are shown in the following Table 3. Further, for reference, measurement results of oxidation-reduction potential of tap water and the like are also shown in the following Table 3.

TABLE 3

| | pH before addition | pH after addition |
|---|---|---|
| Example 1 | 7.1 | 9.6 |
| Comparative | 7.1 | 6.2 |
| Example 1 | | |
| | Oxidation-reduction | Oxidation-reduction |
| | potential before | potential after |
| | addition | addition |
| Example 1 | 333 mV | 142 mV |
| Comparative | 333 mV | 294 mV |
| Example 1 | | |
| | Oxidation-reduction | |
| | potential | |
| Tap water | 547 mV | |
| Distilled water | 333 mV | |
| Commercially | 321 mV | |
| available | | |
| natural water A | | |
| Commercially | 258 mV | |
| available | | |
| natural water B | | |

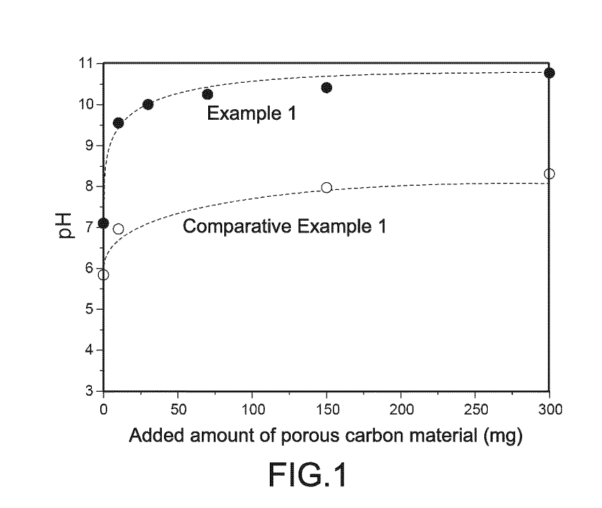

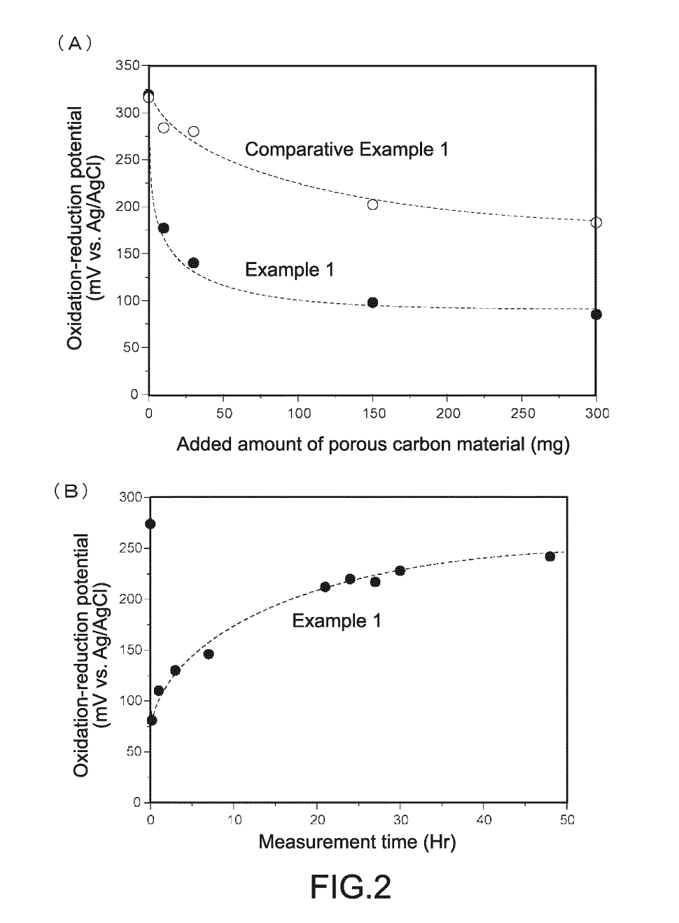

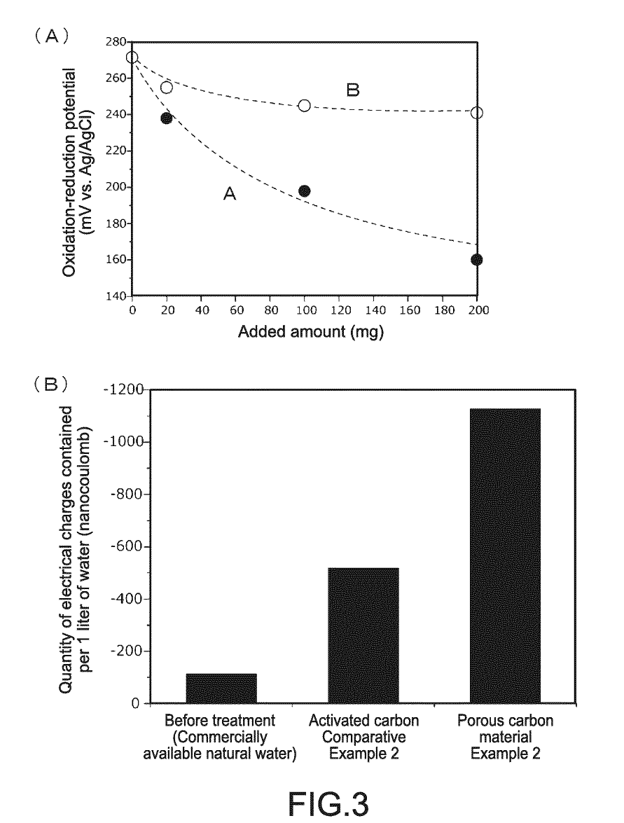

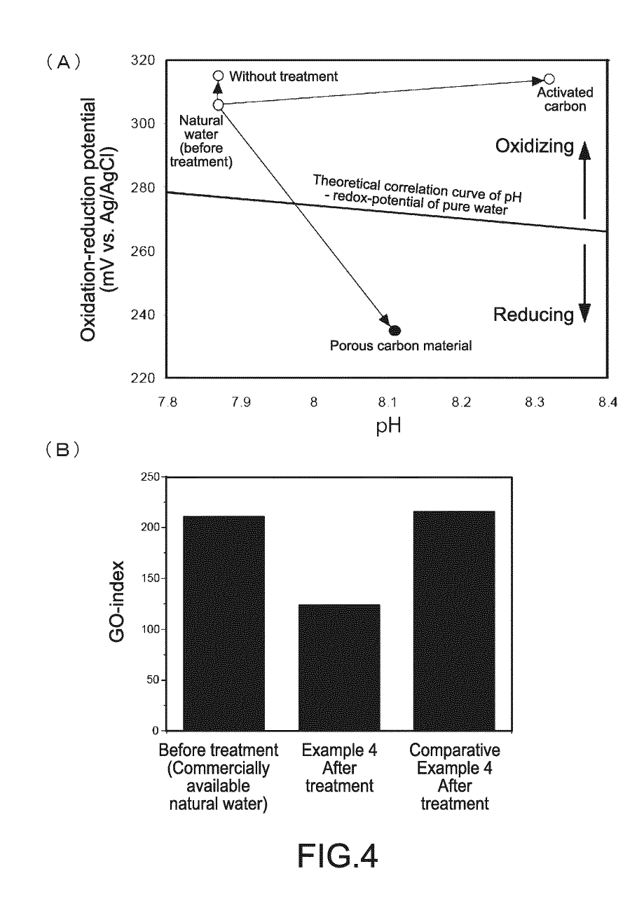

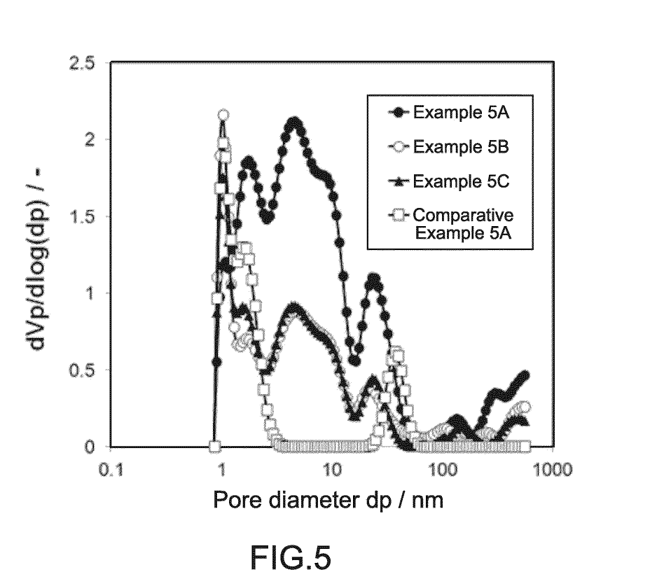

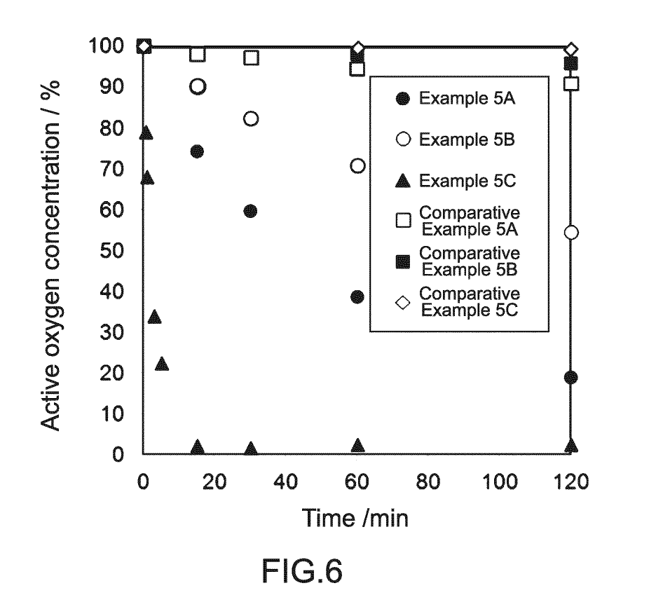

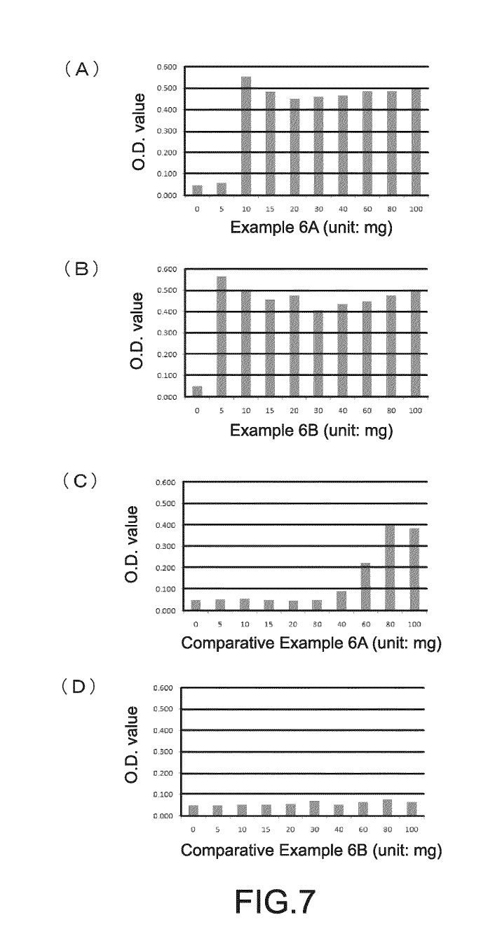

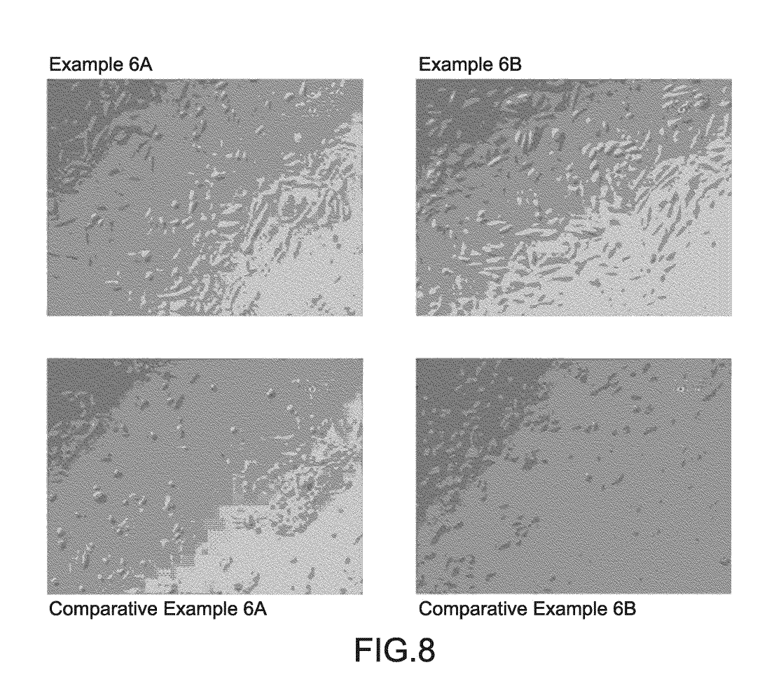

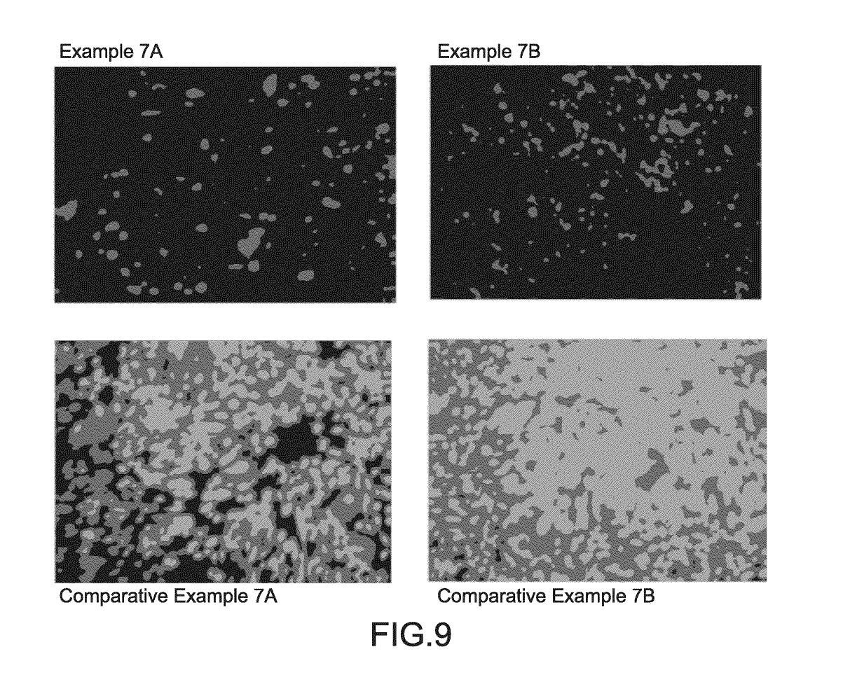

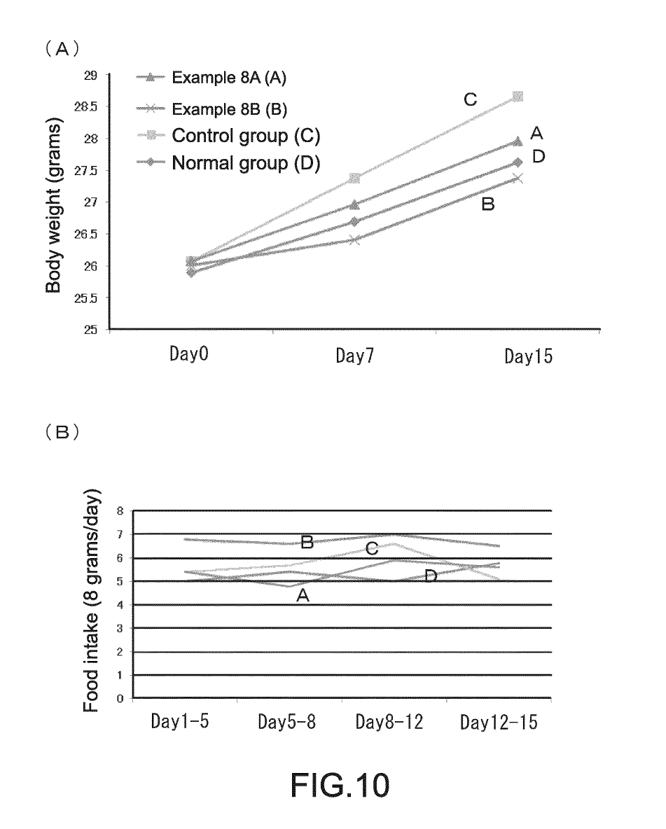

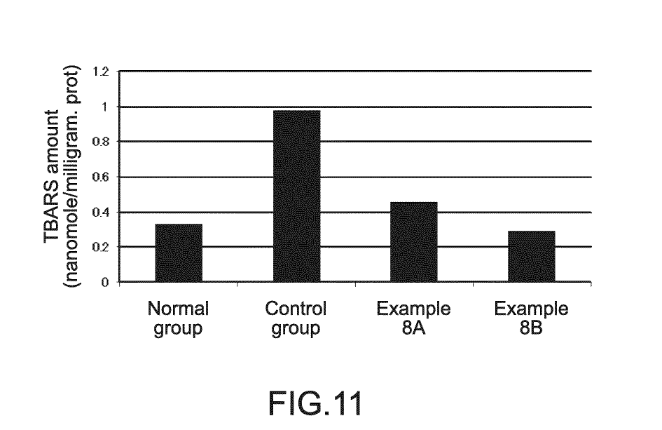

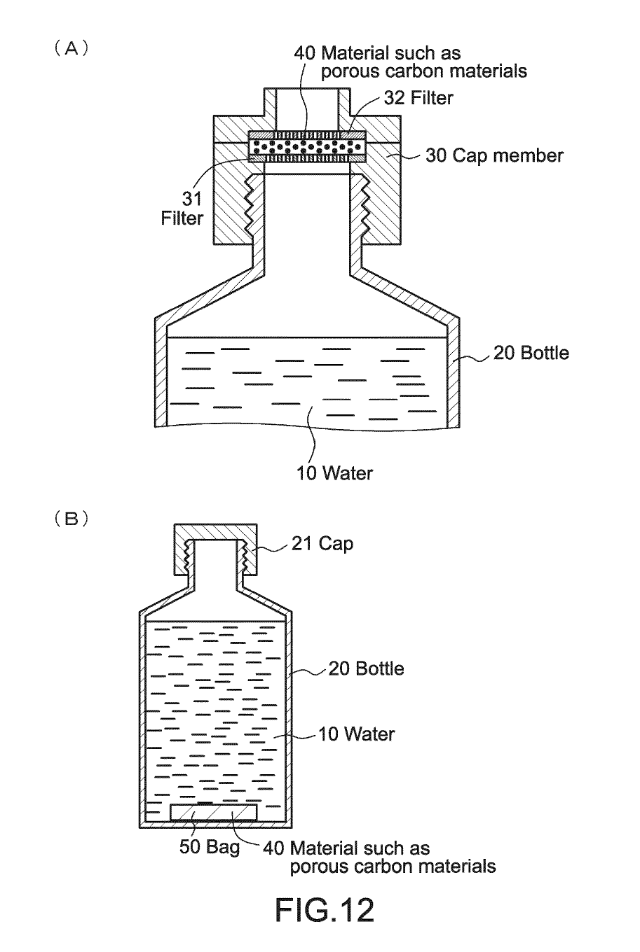

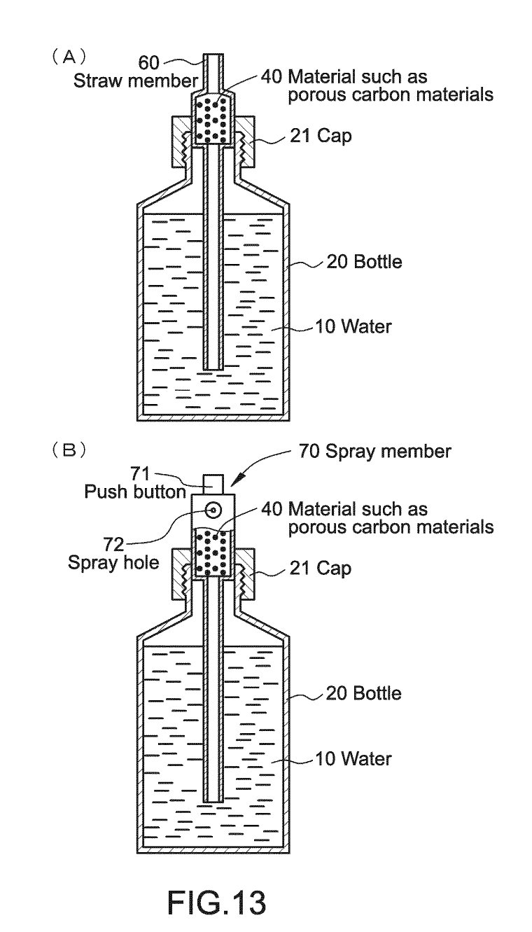

In addition, results of examination of the relationship between added amount of each of a porous carbon material of Example 1 and activated carbon of Comparative Example 1 and pH are shown in a graph of FIG. 1. Further, the relationship between added amount of each of the porous carbon material of Example 1 and activated carbon of Comparative Example 1 and oxidation-reduction potential is shown in a graph of (A) of FIG. 2; and the changes over time in the oxidation-reduction potential in the porous carbon material of Example 1 is shown in (B) of FIG. 2. To 20 milliliters of distilled water, 300 milligrams, 150 milligrams, 70 milligrams, 30 milligrams or 10 milligrams of a specimen was added, followed by stirring for 1 minute, and the oxidation-reduction potential and pH, of the resulting water after its filtration, were measured.

In Example 1, as compared with Comparative Example 1, the pH value of the water after addition of the porous carbon material was increased, and the value of the oxidation-reduction potential after the addition was greatly decreased. Furthermore, as described above, the relative amount of removal of the hydroxyl radicals was 4.0, and it was found to be capable of removing the hydroxyl radicals with high efficiency.

### Example 2

Example 2 is a modification of Example 1. Physical properties of the porous carbon material and the activated carbon which were used as Example 2 and Comparative Example 2 are as shown in Tables 1 and 2.

In Example 2, to 50 milliliters of commercially available natural water, 20 milligrams to 200 milligrams of the porous carbon material of Example 2, and the activated carbon of Comparative Example 2, were added, followed by shaking for 1 minute, then filtration was performed by a syringe filter, and the oxidation-reduction potential of the resulting water after its filtration was measured. The results are shown in (A) of FIG. 3. As compared with the activated carbon of Comparative Example 2 (see curve “B” in (A) of FIG. 3), it was found that with the porous carbon material of Example 2 (see curve “A” in (A) of FIG. 3), the oxidation-reduction potential changes greatly to the reducing side.

The changes in mineral content in the water before and after the filtration treatment by the porous carbon material of Example 2 and the activated carbon of Comparative Example 2 were analyzed based on ICP measurement (unit: ppm). The results are shown in Table 4. There were almost no significant changes to be seen in Example 2 and Comparative Example 2. In addition, the amount of carbonate ion (CO₃⁻) by ion chromatography did not change. From the analysis result of the above, it is considered that there is almost no increase of hydroxide ions by the porous carbon material of Example 2 and the activated carbon of Comparative Example 2.

TABLE 4

| | Natural water | After | After treatment |
|---|---|---|---|
| | before | treatment with | with Comparative |
| | treatment | Example 2 | Example 2 |
| Ca | 9.39 | 9.46 | 9.52 |
| K | 1.81 | 1.88 | 1.92 |
| Mg | 1.81 | 1.84 | 1.86 |
| Na | 5.70 | 5.91 | 6.27 |
| Si | 11.1 | 11.3 | 11.5 |
| CO₃⁻ | 50 | 50 | 50 |

Results of measurement of negative charge quantity in water before and after filtration are shown in (B) of FIG. 3. In the measurement of charge quantity in water, a Coulomb meter and a Faraday cup (both manufactured by Kasuga Denki Co., Ltd.) were used. Specifically, to 50 milliliters of commercially available natural water, 20 milligrams of the porous carbon material of Example 2, and the activated carbon of Comparative Example 2, were added, followed by shaking for 1 minute, then filtration was performed by a syringe filter, and the negative charge quantity was measured.

It was confirmed that by performing the filtration treatment using the porous carbon material of Example 2, the negative charge quantity in water has become very large. It has been known for a long time in the area of electrostatics that water becomes negatively charged. It can be presumed that the porous carbon material of Example 2 has higher tendency to contact with water due to the presence of pores in the region of meso to macro, and it is easy to cause friction in water molecules, which may easily allow the water to be negatively charged on the basis of the Leonard effect.

### Example 3

Example 3 is also a modification of Example 1. In Example 3, 20 milligrams of the porous carbon material which is the same as in Example 2 was added to 50 milliliters of commercially available natural water placed in a 100-milliliter glass beaker (that is, in a state of being in contact with air), and after allowing to stand for 5 minutes in a stationary state, the pH and the oxidation-reduction potential were measured and the effects against aging of water quality were observed. A similar test was performed using 20 milligrams of the activated carbon which is the same as in Comparative Example 2. The results are shown in (A) of FIG. 4.

A theoretical correlation curve between pH and oxidation-reduction potential of water is shown in (A) of FIG. 4. The water of the upper area from the theoretical correlation curve can be defined as oxidative, and the water of the lower area can be defined as reductive. The water in which the porous carbon material of Example 3 coexists was found to be transited to the reductive area. Thus, from the above results, the porous carbon material of Example 3 was found to be capable of preventing or suppressing the aging of the water effectively. Here, summarizing the relationship between the oxidation-reduction potential of the water before treatment and the oxidation-reduction potential of the water after treatment, the porous carbon material of the Example is a porous carbon material which is capable of lowering the oxidation-reduction potential by 50 millivolts or more by being allowed to stand in drinkable water (or water) whose oxidation-reduction potential, as measured with the use of a three-electrode electrometer including an Ag/AgCl electrode as a reference electrode, is from 100 millivolts to 1000 millivolts. The filter medium is a filter medium which is capable of lowering the oxidation-reduction potential by 50 millivolts or more upon filtration of the drinkable water (or water) whose oxidation-reduction potential, as measured with the use of a three-electrode electrometer including an Ag/AgCl electrode as a reference electrode, is from 100 millivolts to 1000 millivolts.

### Example 4

Example 4 is also a modification of Example 1. It is possible to evaluate antioxidant properties (reducing properties) of water by quantifying the oxidation induction rate of deoxyguanosine which make up genes (see, for example, Japanese Unexamined Patent Application Publication No. 2001-272388). When 2′-deoxyguanosine (dG) is oxidized, it is induced to 8-hydroxy-2′-deoxyguanosine (8OHdG). This induction by oxidation from dG to 8OHdG (referred to as “oxidation induction of deoxyguanosine”) can be a biological toxicity index in a broad sense. That is, as 2′-deoxyguanosine (dG) is a material that makes up genes, the more it is oxidized, the more it is likely to lead to damage in genes. The oxidation induction of deoxyguanosine for water can be represented as GO-index by the following formula (reference: see Takagi et al., Medical Technology, Vol. 34, No. 4, 2006).

GO-index=(oxidation induction rate of deoxyguanosine)/(decomposition rate of 8OHdG)

In Example 4 and Comparative Example 4, the same porous carbon material as in Example 2 and the same activated carbon as in Comparative Example 2 were used. The results of measurement of GO-index for natural water treated with the porous carbon material of Example 4 and natural water treated with the activated carbon of Comparative Example 4 are shown in (B) of FIG. 4. Specifically, natural water was treated by a method in which 50 milligrams of the porous carbon material of Example 4 or the activated carbon of Comparative Example 4 is added to 50 milliliters of the natural water, followed by stirring for 1 minute, and then being filtered through a syringe and a membrane filter. GO-index can be obtained by a method in which a concentration of 8OHdG having been generated from the oxidation induction of dG by giving each dG-added water a stress by ultraviolet or addition of KBrO₃, and a concentration of dG, is detected by High-Speed Liquid Chromatography (HPLC) (in the water with high antioxidant properties, the amount of 8OHdG detected would be small). In the water treated with the porous carbon material of Example 4, GO-index would be significantly decreased as compared with that before treatment. On the other hand, there was almost no change in GO-index in the water treated with the activated carbon of Comparative Example 4. Thus, it was confirmed that by treating with the porous carbon material of Example 4, the water which does not oxidize 2′-deoxyguanosine (dG), that is, the water with high antioxidant properties, can be generated.

### Example 5

Example 5 is also a modification of Example 1. As antioxidants which have been used from the past to address the active oxygen, organic molecules such as L-ascorbic acid (vitamin C) and α-tocopherol (vitamin E) can be mentioned. However, in addition to that these materials are in low stability, they have a problem that the material itself would be oxidized by a single reduction action and lose the function. Besides, polymeric antioxidants such as superoxide dismutase and catalase have a problem that reaction conditions in which the effect is exhibited would be limited.

Results of measurement of specific surface area and fine pore volume of a porous carbon material used in Example 5 and an activated carbon used in Comparative Example 5A are shown in Table 5. Further, results of measurement based on the NLDFT method are shown in Table 6. Measurement results, obtained by non-localized density functional theory method, of pore diameter distribution of Example 5A, Example 5B, Example 5C and Comparative Example 5A are shown in a graph of FIG. 5. In Table 5, a “fine pore volume” represents the results of measurement of volumes by a BET method, and a unit thereof is cm²/g.

TABLE 5

| | Specific | fine | | |
|---|---|---|---|---|
| | surface | pore | MP | BJH |
| | area | volume | method | method |
| Example 5A | 2149 | 1.932 | 0.9105 | 1.3419 |
| Example 5B | 1423 | 1.016 | 0.6126 | 0.5652 |
| Example 5C | 1329 | 0.9611 | 0.5857 | 0.5421 |
| Comparative | 1190 | 0.5681 | 0.5180 | 0.1116 |
| Example 5A | | | | |

TABLE 6

| | | Sum total of volumes |
|---|---|---|
| | Volume ratio | of all fine pores |
| Example 5A | 0.4743 | 2.486 cm³/g |
| Example 5B | 0.3352 | 1.433 cm³/g |
| Example 5C | 0.3649 | 1.332 cm³/g |
| Comparative | 0.0005 | 0.8681 cm³/g |
| Example 5A | | |

The porous carbon materials of Examples 5A and 5B were manufactured by the method substantially similar to the method described in Example 1. The porous carbon material of Example 5C was manufactured by the method substantially similar to the method which will be described later in Example 9. In addition, the activated carbon of Comparative Example 5A is an activated carbon made of coconut shells manufactured by Wako Pure Chemical Industries Ltd.

Results of evaluation of properties of decomposing hydrogen peroxide, evaluated by spectroscopy, of specimens of Example 5A, Example 5B, Example 5C, Comparative Example 5A, Comparative Example 5B and Comparative Example 5C are shown in FIG. 6. Ability to decompose hydrogen peroxide of each specimen is shown in Table 7. In addition, L-ascorbic acid was used as Comparative Example 5B, and fullerene was used as Comparative Example 5C. The properties of decomposing hydrogen peroxide were evaluated based on spectroscopy. From Table 7 and FIG. 6, it was found that the ability to decompose hydrogen peroxide of the porous carbon materials of Examples 5A to 5C, especially, the porous carbon material of Example 5C, was significantly larger than in the specimens of Comparative Examples 5A to 5C. That is, the ability to decompose hydrogen peroxide in the porous carbon material of the present disclosure was found to be 5×10 mmol·h⁻¹·g⁻¹ or more.

TABLE 7

| | Ability to decompose |
|---|---|
| | hydrogen peroxide/ |
| | mmol · h⁻¹ · g⁻¹ |
| Example 5A | 81 |
| Example 5B | 45 |
| Example 5C | 781 |
| Comparative Example 5A | 9.1 |
| Comparative Example 5B | 4.2 |
| Comparative Example 5C | 0.6 |

### Example 6

Example 6 is also a modification of Example 1. In Example 6, a variety of specimens was added to hydrogen peroxide in various concentrations, followed by incubating for 2 hours at 37° C. while stirring by inverting. Then it was filtered by a filter, and the resulting filtrate was 10-fold diluted with a medium to obtain a sample solution. Subsequently, normal human epidermal cells were plated in a 96-well plate at 1×10⁴ cells/100 microliters/well, followed by addition of the sample solution. Then, after a 2-hour culture in a CO₂ incubator (5% CO₂, 37° C.), the medium was replaced with a serum-free medium for epidermal cells. After 24 hours, viable cells were stained with reagent SF for cell viability assay. Amounts of viable cells were evaluated for five samples, considering the amount of viable cells as O.D. value. Further, the cells were observed through an optical microscope. In Example 6A, the same porous carbon material as in Example 5B was used. In Example 6B, the same porous carbon material as in Example 5C was used. In Comparative Example 6A, the same material as in Comparative Example 5B was used. In Comparative Example 6B, the same material as in Comparative Example 5C was used. The obtained O.D. values are shown in FIG. 7. In addition, optical microscope images of the cells after the test in the case of the added amount of 40 milligrams are shown in FIG. 8.

From FIG. 7, it can be seen that the viability of epidermal cells has increased by increasing the addition ratio of the porous carbon material of Examples 6A and 6B. In addition, the amount of viable cells was much larger as compared with Comparative Examples 6A and 6B, and it can be seen that the added amount necessary for increasing the amount of viable cells may be small. Further, from FIG. 8, with the added amount of 40 milligrams, while the cells in Examples 6A and 6B have survived, cell death was observed in Comparative Examples 6A and 6B. It can be considered that this is because active oxygen was efficiently removed by the porous carbon material of Examples 6A and 6B, as compared with Comparative Examples 6A and 6B.

### Example 7

Example 7 is also a modification of Example 1. In Example 7, a variety of specimens was added to 15 milliliters of a phosphate buffer (to which hydrogen peroxide was added), followed by stirring by rotating roller for 2 hours at 37° C., and the resultant solution was filtered by a filter. Meanwhile, cells were cultured in a chamber slide to incorporate a fluorescent probe. Then, after a variety of the prepared sample solutions to which hydrogen peroxide was added was 10-fold diluted with a medium, the sample solution was added to the cells which have incorporated the fluorescent probe, and the cells were allowed to stand for 15 minutes at room temperature. Finally, fluorescence photographs were taken using a fluorescence microscope and a digital camera. In Example 7A, the same porous carbon material as in Example 5B was used. In Example 7B, the same porous carbon material as in Example 5C was used. On the other hand, in Comparative Example 7A, the same material as in Comparative Example 5B was used. In Comparative Example 7B, the same material as in Comparative Example 5C was used. In all the specimens, the added amount is 80 milligrams. The obtained fluorescence microscope images are shown in FIG. 9. From FIG. 9, it can be seen that while generation of active oxygen is suppressed in Examples 7A and 7B, active oxygen is generated in the cells by oxidative stress in Comparative Examples 7A and 7B.

### Example 8

Example 8 is also a modification of Example 1. In Example 8, the same porous carbon material as in Example 5B was used. By feeding mice with powder diet containing 0.14 mass % of iron, the amount of lipid peroxide in their intestinal mucosa was made to increase. After a 14-day repeated oral administration of the porous carbon material of Example 8 to these mice, an effect thereof was evaluated.

Specifically, mice after the habituation period were fed with normal powder diet or the powder diet containing 0.14 mass % of iron, and at the same time, a dosing solution in which the porous carbon material of Example 8 was dispersed in distilled water was administered orally once daily for 14 days repeatedly. On the day following the last oral administration, the mice were euthanized by blood removal under isoflurane anesthesia, and after that, their colon were collected. By measuring the amount of lipid peroxide contained in the intestinal mucosa thereof, the effect of the porous carbon material of Example 8 of lowering the amount of lipid peroxide was evaluated.

Incidentally, the powder diet containing 0.14 mass % of iron was prepared by adding 1680 milligrams of iron for mixing in diet to normal powder diet to obtain the entire mass of 1200 grams. The dosing solution was prepared by weighing 500 milligrams of the porous carbon material and adding distilled water as a medium to make it 10 milliliters, thus preparing a 500-milligram porous carbon material/kilogram dosing solution. Or, by weighing 1000 milligrams of the porous carbon material and adding distilled water as a medium to make it 10 milliliters, a 1000-milligram porous carbon material/kilogram dosing solution was prepared.

Setting the first day of feeding the powder diet containing iron as Day 1, the weight of mice in each test group was measured on Day 0, Day 7 and Day 15, and a comparison between the mean value for the group fed with the powder diet containing 0.14 mass % of iron (control group) and the mean value for each test group was made. The results are shown in (A) of FIG. 10, and significant differences in the mean value of weight between the control group and the other test group were not observed in any of the measurement days.

Further, the food dosage was measured on Day 1, Day 5, Day 8 and Day 12, and quantity of the remained food was measured on Day 5, Day 8, Day 12 and Day 15. Then, the average food intake per day was calculated from the measured values. The results are shown in (B) of FIG. 10. As a result of comparing the food intake per day between the control group and each test group, significant differences the average food intake between the control group and the other test group were not observed in any of the measurement days.

On the day following the last day of the repeated oral administration, intestinal mucosa of the mice, which were euthanized, were collected and concentrations of lipid peroxide contained were measured. Specifically, the intestinal mucosa peeled from the collected colon was placed in 500 microliters of 1.15% KCl solution and was homogenized. Then, the resulting homogenized product was centrifuged at 13000 g for 15 minutes, followed by recovering the supernatant to obtain a specimen for a measurement of amount of lipid peroxide in intestinal mucosa and a measurement of amount of protein. That is, after thoroughly stirring the specimen for measurement, the amount of protein in the specimen was measured using a protein concentration measurement kit.

Further, the amount of lipid peroxide was measured based on TBARS method. Specifically, each specimen for measurement was thoroughly stirred and was aliquoted in 100 microliter volumes to test tubes with lid. In the similar manner, malondialdehyde bis standard solutions (0 nanomole/milliliter, 2.5 nanomole/milliliter, 5 nanomole/milliliter, 10 nanomole/milliliter, 20 nanomole/milliliter, 30 nanomole/milliliter, 40 nanomole/milliliter and 50 nanomole/milliliter) were aliquoted in 100 microliter volumes to test tubes with lid. Further, after adding thereto 325 microliters of TBA reaction solution and 75 microliters of 20% acetic acid buffer solution (pH3.5) and thoroughly stirring them, the resulting mixture was allowed to stand on ice for 1 hour. Subsequently, the test tubes were heated for 1 hour in a warm bath of 100° C. After heating, the test tubes were cooled, 800 microliters of a butanol-pyridine solution (mass ratio 15:1) was added to each test tube and the resulting mixture was vigorously stirred. This was pipetted to microtubes, and was subjected to centrifugation at 2000 g for 5 minutes at 4° C. After the centrifugation, a concentration of TBARS in the upper layer (butanol-pyridine layer) was measured by a fluorescence spectrophotometer at an excitation wavelength of 515 nm and a measurement wavelength of 535 nm, and the lipid peroxide concentration in the specimen for measurement was calculated. The amount of lipid peroxide in intestinal mucosa was calculated as nanomole/milligram. prot (content per the tissue of intestinal mucosa of 1 milligram of protein) based on the measured mass of the protein. The measured TBARS amount is shown in FIG. 11.

As a result, it was found that the control group shows a significantly higher amount of lipid peroxide in intestinal mucosa (P=0.0098) as compared with the normal diet group (normal group). Further, as compared with the control group, significantly lower amounts of lipid peroxide in intestinal mucosa were observed in both administration groups of each group in which 500-milligram porous carbon material of Example 8/kilogram was administered (P=0.0397) (Example 8A) and each group in which 1000-milligram porous carbon material of Example 8/kilogram was administered (P=0.0074) (Example 8B).

Thus, the group fed with the powder diet containing 0.14 mass % of iron for 2 weeks (control group) showed a significantly higher amount of lipid peroxide in intestinal mucosa as compared with the normal diet group (normal group). From this result, it can be considered that a model of increase in amount of lipid peroxide in intestinal mucosa by intake of iron-containing diet was able to be created. Further, as a result of a 14-day repeated gavage administration of the porous carbon material of Example 8 that was dispersed in distilled water, as compared with the control group, the groups in which the porous carbon material of Example 8 was administered were able to suppress increase in amount of lipid peroxide in intestinal mucosa, depending on dosages, and it was found that both groups of each group in which 500-milligram/kilogram was administered and each group in which 1000-milligram/kilogram was administered would exhibit a significant effect of suppression. In particular, from that each group in which the porous carbon material of Example 8 of 1000-milligram/kilogram was administered has shown about the same level of amount of lipid peroxide in intestinal mucosa as the normal group, the porous carbon material of Example 8 can be considered likely to have a strong antioxidant effect. The porous carbon material of Example 8, without causing a significant weight loss even in the repeated oral administration thereof, was suggested to be able to exhibit a strong inhibitory effect on increase in amount of lipid peroxide in intestinal mucosa by intake of iron-containing diet.

### Example 9

Example 9 relates to a method according to the fourth embodiment of the present disclosure for removing oxidative stress substances, a filter medium according to the seventh embodiment of the present disclosure, and water (specifically, drinkable water or a lotion) according to the seventh embodiment of the present disclosure. In Example 9, a porous carbon material composite including a porous carbon material and a functional material attached to this porous carbon material, which porous carbon material composite has a value of a specific surface area based on nitrogen BET method of 10 m²/g or more, a volume of fine pores based on BJH method of 0.2 cm³/g or more, desirably 0.4 cm³/g or more, and a volume of fine pores based on MP method of 0.2 cm³/g or more, desirably 0.4 cm³/g or more, is used. Or, a porous carbon material composite having a value of a specific surface area based on nitrogen BET method of 10 m²/g or more, and a total of volumes of fine pores having a diameter of from 1×10⁻⁹ m to 5×10⁻⁷ m, obtained by non-localized density functional theory method (NLDFT method), of 0.1 cm³/g or more, desirably 0.2 cm³/g or more, is used. Or, a porous carbon material composite having a value of a specific surface area based on nitrogen BET method of 10 m²/g or more and having at least one peak in the range of 3 nm to 20 nm, in a pore diameter distribution obtained by non-localized density functional theory method, in which, a ratio of a total of volumes of fine pores which have pore diameters in the range of 3 nm to 20 nm, with respect to a sum total of volumes of all fine pores, is 0.2 or more is used.

By allowing the porous carbon material composite to be immersed in a liquid (water), oxidative stress substances in the liquid (water) are removed. Further, the filter medium removes oxidative stress substances contained in a liquid (water) by being immersed in the liquid (water). Still further, the water is the water (drinkable water or a lotion) from which oxidative stress substances are removed by being impregnated into the porous carbon material.

In Example 9, a metallic material (specifically, fine particles of platinum or platinum nanoparticles) being attached to a porous carbon material was used as a functional material. The porous carbon material was manufactured by the method substantially similar to the method described in Example 1.

More specifically, in Example 9, to 182 milliliters of diluted water, 8 milliliters of 5-millimole H₂PtCl₆ aqueous solution and 3.5 milligrams of L-ascorbic acid (surface protecting agent) were added, followed by stirring for a while. Subsequently, 0.43 grams of the porous carbon material described in Example 1 was added to the resulting mixture, and then after an ultrasonic irradiation for 20 minutes, 10 milliliters of 40-millimole NaBH₄ aqueous solution was added thereto, followed by stirring for 3 hours. After that, by filtering with suction and drying at 120° C., a porous carbon material composite of Example 9, which is a black powder specimen, was obtained.

In Example 9, as described above, the relative amount of removal of the hydroxyl radicals was 9.8, and it was found to be capable of removing the hydroxyl radicals with higher efficiency than in Example 1.

### Example 10

Example 10 is a modification of Examples 1 to 9. In Example 10, as a schematic partial sectional view is shown in (A) of FIG. 12, each of the porous carbon materials or porous carbon material composites (hereinafter, referred to as a “material such as porous carbon materials 40”) described in Examples 1 to 9 was assembled in a bottle (so-called PET bottle) 20 with a cap member 30. Specifically, inside the cap member 30, the material such as porous carbon materials 40 was disposed and filters 31 and 32 were disposed on a liquid inlet side and a liquid outlet side of the cap member 30 to prevent the material such as porous carbon materials 40 from eluting off. Then, when liquid or water (drinkable water, a lotion, or the like) 10 in the bottle 20 is drunk or used by passing through the material such as porous carbon materials 40 disposed inside the cap member 30, for example, oxidative stress substances in the liquid (water) can be removed, or, the oxidation-reduction potential of the liquid (water) can be lowered. That is, just prior to drinking it or using it, oxidative stress substances in the liquid (water) can be removed, or, the oxidation-reduction potential of the liquid (water) can be lowered. Incidentally, the cap member 30 is usually kept closed with a lid (not shown).

Or, as a schematic sectional view is shown in (B) of FIG. 12, a form in which a material such as porous carbon materials 40 is housed in a permeable bag 50 and the bag 50 is put into a liquid or water (drinkable water, a lotion, or the like) 10 in a bottle 20 can be adopted. A reference numeral 21 denotes a cap for closing an opening of the bottle 20. Or, as a schematic sectional view is shown in (A) of FIG. 13, a material such as porous carbon materials 40 is disposed inside a straw member 60 and a filter (not shown) is disposed on a liquid inlet side and a liquid outlet side of the straw member to prevent the material such as porous carbon materials 40 from flowing off. Then, when a liquid or water (drinkable water) 10 in the bottle 20 is drunk by passing through the material such as porous carbon materials 40 disposed inside the straw member 60, oxidative stress substances in the liquid (water) can be removed, or, the oxidation-reduction potential of the liquid (water) can be lowered. Or, as a partially cutaway schematic diagram is shown in (B) of FIG. 13, a material such as porous carbon materials 40 is disposed inside a spray member 70 and a filter (not shown) is disposed on a liquid inlet side and a liquid outlet side of the spray member 70 to prevent the material such as porous carbon materials 40 from flowing off. Then, by pushing a push button 71 provided to the spray member 70 to allow a liquid or water (drinkable water, a lotion, or the like) 10 inside the bottle 20 to pass through the material such as porous carbon materials 40 disposed inside the spray member 70 to spray from a spray hole 72, oxidative stress substances in the liquid (water) can be removed, or, the oxidation-reduction potential of the liquid (water) can be lowered.

In the above, the present disclosure was described based on preferred examples. However, the present disclosure is not limited to these examples and can be variously modified. In Examples, a case where as a raw material of a porous carbon material, rice husks are used was described. However, other plant-derived raw materials may be used. Here, as other plants, for example, straws, reeds, or Wakame stems, vascular plants that live on land, ferns, bryophytes, algae, seaweeds and the like can be mentioned. These materials may be used singularly or in a combination of several kinds thereof. Specifically, by carbonizing, for example, rice straws (for example, the Isehikari produced in Kagoshima) as a plant-derived material, which is a raw material of a porous carbon material, into a carbonaceous substance (porous carbon material precursor), followed by performing an acid treatment, a porous carbon material can be obtained. Alternatively, by carbonizing rice reeds as a plant-derived material, which is a raw material of a porous carbon material, into a carbonaceous substance (porous carbon material precursor), followed by performing an acid treatment, a porous carbon material can be obtained. Further, also in a porous carbon material obtained by treating with, in place of an aqueous solution of hydrofluoric acid, an alkali (base) such as an aqueous solution of sodium hydroxide, the same result could be obtained. In addition, a method for manufacturing the porous carbon material or porous carbon material composite may be the same as in Examples 1, 5 and 9.

Or, by carbonizing Wakame stems (produced in Sanriku in Iwate) as a plant-derived material, which is a raw material of a porous carbon material, into a carbonaceous substance (porous carbon material precursor), followed by performing an acid treatment, a porous carbon material can be obtained. Specifically, first, for example, Wakame stems are heated at a temperature of about 500° C. to carbonize. Before heating, for example, raw material Wakame stems may be treated with alcohol. As a specific processing method, a method of dipping in ethyl alcohol or the like can be mentioned, thereby, a water content contained in the raw material can be reduced and other elements other than carbon and mineral components, which are contained in a finally obtained porous carbon material, can be eluted. Further, by treating with alcohol, a gas can be suppressed from generating during carbonizing. More specifically, Wakame stems are dipped in ethyl alcohol for 48 hours. It is desirable to apply an ultrasonic treatment in ethyl alcohol. Then, by heating the Wakame stems at 500° C. for 5 hours in a nitrogen gas flow to carbonize, a carbide is obtained. By performing such a treatment (preliminary carbonizing treatment), a tar component that would be generated during the subsequent carbonizing process can be reduced or removed. Thereafter, 10 g of the carbide is charged in an alumina crucible and heated up to 1000° C. at a rate of temperature increase of 5° C./min in a nitrogen gas flow (10 L/min). Then, after carbonizing at 1000° C. for 5 hours to convert to a carbonaceous substance (porous carbon material precursor), the carbonaceous substance is cooled to room temperature. During carbonizing and cooling, a nitrogen gas is continued to flow. Next, the porous carbon material precursor is treated with an acid by dipping in an aqueous solution of 46% by volume of hydrofluoric acid overnight, and, after that, the resultant is washed using water and ethyl alcohol until pH7 is obtained. Then, by finally drying, a porous carbon material can be obtained.

When the plant containing at least one component selected from the group consisting of sodium, magnesium, potassium and calcium (specifically, for example, skin of citrus fruits such as mandarin orange skin, orange skin and grapefruit skin, and banana skin), is used as the raw material of the porous carbon material, the porous carbon material allows elution of a large amount of mineral components to water, and can control the hardness of water. In this case, it is desirable that the sodium (Na), magnesium (Mg), potassium (K) and calcium (Ca) which are contained in the porous carbon material is 0.4% by mass or more, in total.

### DESCRIPTION OF REFERENCE NUMERALS

10 water
20 bottle
21 cap
30 cap member
31, 32 filter
40 material such as porous carbon materials
50 bag
60 straw member
70 spray member
71 push button
72 spray hole

1. (canceled)

2. A method for removing oxidative stress substances, the method comprising:
using a porous carbon material having
a value of a specific surface area based on nitrogen BET method of 10 m²/g or more; and
a total of volumes of fine pores having a diameter of from 1×10⁻⁹ m to 5×10⁻⁷ m, obtained by non-localized density functional theory method, of 0.1 cm³/g or more;
to remove oxidative stress substances contained in a liquid.

3-9. (canceled)

10. A filter medium comprising:
a porous carbon material having
a value of a specific surface area based on nitrogen BET method of 10 m²/g or more and
a total of volumes of fine pores having a diameter of from 1×10⁻⁹ m to 5×10⁻⁷ m, obtained by non-localized density functional theory method, of 0.1 cm³/g or more;
wherein the filter medium is configured to remove oxidative stress substances contained in a liquid by being immersed in the liquid.

11-16. (canceled)

17. Water,
from which oxidative stress substances are removed by being impregnated into a porous carbon material having
a value of a specific surface area based on nitrogen BET method of 10 m²/g or more and
a total of volumes of fine pores having a diameter of from 1×10⁻⁹ m to 5×10⁻⁷ m, obtained by non-localized density functional theory method, of 0.1 cm³/g or more.

18-21. (canceled)
